(19) United States
(12) Patent Application Publication
(10) Pub. No.: US 2002/0147593 A1
(43) Pub. Date: Oct. 10, 2002

(54) Categorized speech-based interfaces

(75) Inventors: James R. Lewis, Delray Beach, FL (US); Wallace J. Sadowski, West Palm Beach, FL (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: International Business Machines Corporation, Armonk, NY (US)

(21) Appl. No.: 09/827,700

(22) Filed: Apr. 6, 2001

(51) Int. Cl. G10L 11/00

(52) U.S. Cl. 704/275

(57) ABSTRACT

A categorized speech-based interface system includes structure for delivering user prompts to users. The prompts include at least full prompts and tapered prompts. The interface further includes structure for determining the quantity of at least one of correct and incorrect responses to the prompts. The system delivers tapered prompts in response to the determination of a quantity of at least one of the correct and incorrect responses. A method for operating a categorized speech-based interface system is also disclosed.

### BACKGROUND OF THE INVENTION

1. Technical Field

This invention relates generally to speech-based interfaces, and more particularly to categorized speech-based interfaces.

2. Description of the Related Art

Speech-based interfaces have become prevalent because they can be used effectively and efficiently both by novice and expert users. Novice users, however, typically require full prompts with explanatory introductions to system information and directive prompts to successfully and efficiently work with such speech-based interfaces. In contrast, more experienced users, having learned what speech inputs the system requires for advancement, tend to prefer interfaces having prompts that promote the expeditious completion of tasks. Minimizing introductory information and the use of concise prompts permits expert users to complete tasks more promptly. Accordingly, systems configured for expert users are not well-suited for novice users, and systems that are configured for novice users can frustrate expert users.

One speech-based interface technique which has been used to satisfy the needs of expert users employs shortened or “tapered” prompts to elicit speech inputs. The tapered prompts typically do not have, or have as much, explanatory introductions and system information as do complete prompts that are used for novice users. Tapered prompts assist expert users in completing tasks quickly. Some interfaces present tapered prompts to a user when the user returns to the system after prior use. These systems require that prior users be identified as they enter the system. Other systems deliver tapered prompts to a user after the user has cycled through an application's initial node to a terminal node, and then returned to the initial node. Such systems can frustrate the expert user, who may never reach the terminal node, but is nonetheless required to listen to full prompts each time the system is entered.

### SUMMARY OF THE INVENTION

A categorized speech-based interface system comprises structure for delivering user prompts to users. The prompts comprise at least full prompts and tapered prompts. The interface further comprises structure for determining the quantity of at least one of correct and incorrect responses to the prompts from the user. The system delivers tapered prompts to the user in response to the determination of a quantity of said at least one of correct and incorrect responses.

The system can deliver tapered prompts in response to determining that correct responses have been provided by the user to a prerequisite number of full prompts. The system can require a prerequisite proportion of correct responses relative to the total number of prompts to deliver tapered prompts. In another aspect, the system delivers tapered prompts to the user until the user provides an incorrect response. The system delivers full prompts following an incorrect response until a prerequisite number of correct responses to the full prompts are provided by a user.

The prerequisite number of correct responses to full prompts that is necessary to receive tapered prompts can be increased if an incorrect response is received. In one aspect, the prerequisite number of responses to full prompts that is necessary to receive tapered prompts is increased for each sequential incorrect response that is received.

The incorrect responses are determined by comparing the response to predetermined criteria. In one aspect, the incorrect responses are selected from the group consisting of out-of-grammar responses, silence time-outs, and help responses.

The interface can be segmented. Tapered prompts are delivered in a segment in response to determining that correct responses have been provided by a user to a prerequisite quantity of the prompts while in the segment. The prerequisite quantity of correct responses can comprise a prerequisite sequential number of correct responses provided by the user while in the segment. The prerequisite quantity of correct responses can alternatively comprise a prerequisite minimum proportion of correct responses provided by the user while in the segment.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a flow diagram illustrating a simple sequential categorization technique.

FIG. 2 is a flow diagram illustrating a dynamic sequential categorization technique.

FIG. 3 is a flow diagram illustrating a criterion level categorization technique.

### DETAILED DESCRIPTION OF THE PREFERRED EMBODIMENTS

The invention provides a categorized speech-based interface having a prompt delivery system for delivering user prompts to users. The prompts comprise at least full prompts and tapered prompts. The prompt delivery system can determine the quantity of at least one of correct and incorrect responses to delivered prompts. The prompt delivery system can deliver tapered prompts rather than full prompts based upon the quantity determination. For example, a tapered prompt can be delivered where a quantity of correct responses are received, such quantity exceeding a threshold value.

Notably, the term “tapered” prompt refers to a prompt which is shorter in duration than a “full” prompt. Full prompts typically comprise explanatory material and other information to assist the novice user in making the correct choice. A full prompt can also refer to a series of prompts which guide the novice user to an intermediate point in the interface, which series of prompts is not necessary for an expert user. By comparison, a tapered prompt bypasses this series of prompts to arrive at the same intermediate point in the interface.

A simple sequential categorization method for use in accordance with the inventive arrangements can facilitate the establishment by system developers of a fixed ratio of successful responses to full prompts that will activate the delivery of tapered prompts. The prerequisite full prompts may be any number including zero. In consequence, developers can consider both the complexity of the speech-based interface and the foreseeable type of users, both novice and expert, when establishing the number of prerequisite prompts necessary to trigger the delivery of tapered and full prompts.

In operation, when a user has responded correctly to the delivery of a prerequisite number of full prompts, the prompt delivery system can begin to deliver tapered prompts rather than full prompts until the user commits one or more speech-based interface errors, such as an out-of-grammar (OOG) utterance or silence time out. In this case, if the user fails to respond appropriately to the delivery of a tapered prompt, the prompt delivery system can subsequently return to delivering full prompts. Once again, the user must respond properly to the prerequisite number of full prompts before receiving tapered prompts once again. This cycle continues throughout the user's interaction with the speech-based interface.

According to one aspect of the invention, tapered prompts can be delivered to a user after the user has successfully responded to a predetermined quantity of full prompts. By successful response, it is meant that the user has responded in a way which is meaningful to the speech-based interface. For instance, if the prompt delivery system delivers the prompt, “Please say ‘one’ for sales, or ‘two’ for customer service,” and the user replies, “Bananas”, it can be said that the user has not successfully responded to the prompt. Conversely, if the prompt delivery system delivers the prompt, “Please state your name,” and the user replies, “Sigmund”, it can be said that the user has successfully responded to the prompt because the user provided a name.

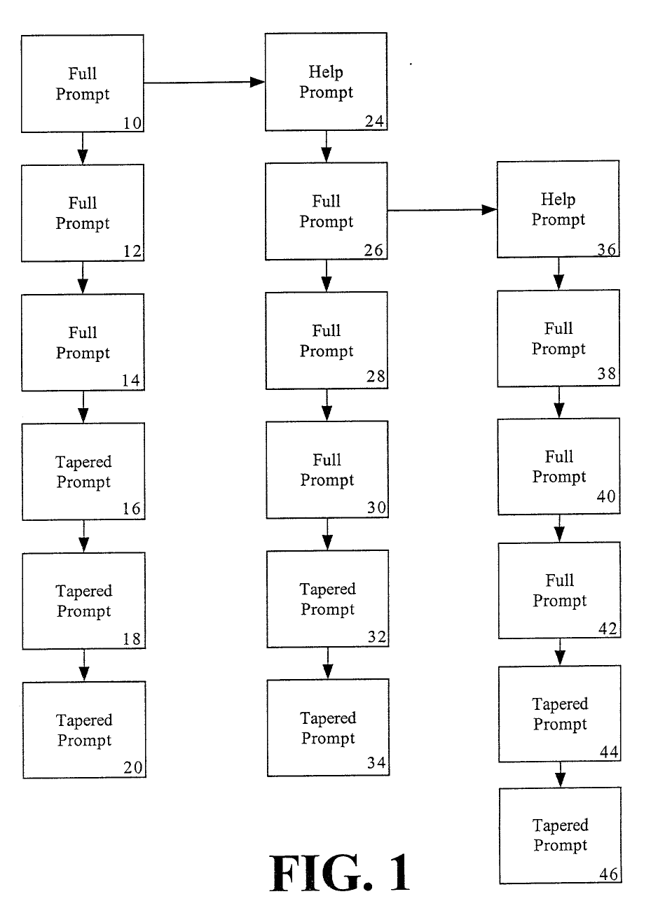

The above-described prompt delivery method can be referred to as a “simple sequential categorization” prompt delivery technique, and is illustrated in FIG. 1. As will be apparent from the figure, the prerequisite number in the example is set at three. Accordingly, three correct responses to full prompts are required for the prompt delivery system to deliver tapered prompts rather than full prompts to the user. The prompt delivery system begins at step 10 by presenting a full prompt to the user. If the user progresses by providing suitable responses to the full prompt 10, a subsequent full prompt 12, and another full prompt 14, a tapered prompt 16 can then be delivered to the user. Tapered prompts are also delivered to the user in steps 18 and 20. By comparison, if the response to the full prompt 10 is incorrect or otherwise results in a help prompt 24, a full prompt is delivered in steps 26, 28, and 30 until correct answers to the prerequisite number of three full prompts has been attained. The prompt delivery system then can deliver tapered prompts again in steps 32 and 34.

At any time, if the user answers incorrectly or otherwise requires a help prompt 36, full prompts can be again delivered in steps 38, 40, and 42 until the prerequisite number of three correct answers to full prompts is again attained. The prompt delivery system then can deliver tapered prompts in steps 44 and 46. Although the invention has been illustrated in FIG. 1 with the prerequisite number set at three full prompts, a prerequisite of fewer or more correct responses to full prompts can alternatively be required. In particular, a developer of the speech-based interface can calculate the quantity of correct responses to full prompts which are required to trigger the delivery of tapered prompts.

As will be apparent to one skilled in the art, in some instances the simple sequential categorization technique of FIG. 1 can penalize experts in terms of time during the prerequisite full prompts, unless the prompt delivery system is full duplex system. A full duplex system allows users to interrupt with speech input before the prompt is complete. This allows experts to interrupt a full prompt to move forward more quickly. Therefore, implementation of the simple sequential categorization technique in a full duplex system suits novices users but does not penalize experts. Performance of novice users should not suffer significantly because an incorrect response to a tapered prompt results in the resumption of full prompts. While this method works most efficiently with full duplex systems, there are reasons why developers may not choose to use a full duplex system. These reasons may include the cost of echo cancellation, usage in environments with substantial extraneous noise, or prompts that must be heard in their entirety, for example legal notices.

By comparison to the simple sequential categorization technique illustrated in FIG. 1, a dynamic sequential categorization method allows developers to establish multiple prerequisite full prompt levels based upon user performance. For example, developers may wish to start with one prerequisite full prompt after users hear an introductory message. Users responding correctly to the full prompt can transition to a tapered prompt interface. Users triggering a first-level help prompt subsequently can receive two prerequisite full prompts. Similarly, users triggering a second-level help prompt subsequently can receive three prerequisite full prompts. This dynamic sequential technique is well suited for half-duplex systems. In particular, the dynamic sequential categorization method allows expert users to rapidly transition to tapered prompts while the method meets the needs of novice users by providing full prompts when tapered prompts prove to be inadequate.

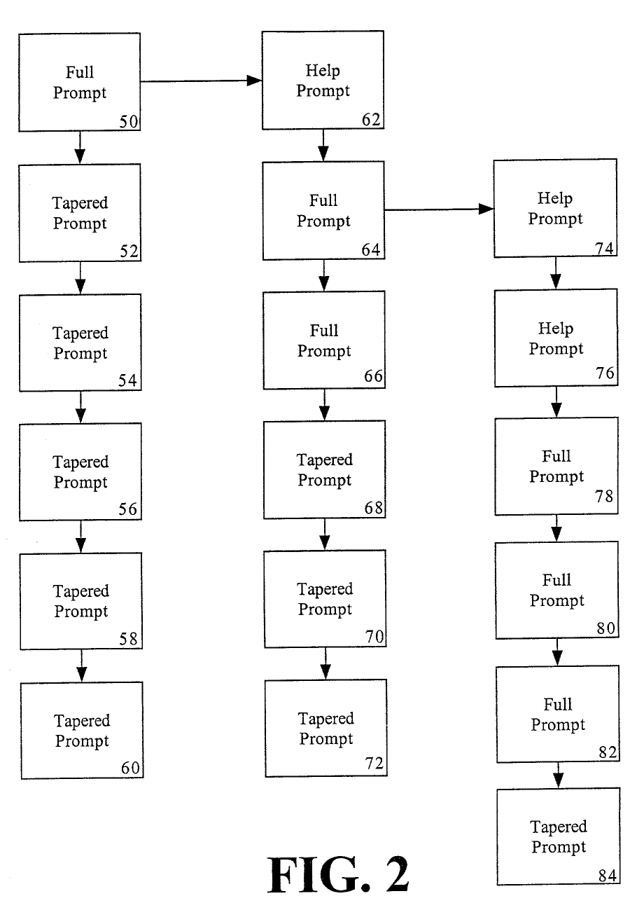

FIG. 2 is a flow chart illustrating a dynamic sequential categorization technique in accordance with the inventive arrangements. In a dynamic sequential categorization technique, a particular ratio of correct responses to full prompts can be determined that, when met or exceeded can trigger the provision of receive tapered prompts. Importantly, as more incorrect responses to full prompts are received, the ratio can be increased. As shown in FIG. 2, initially the ratio of correct responses to full prompts can be preset at one. Subsequently, a full prompt 50 can be delivered. Receiving a correct response to the initially delivered full prompt can trigger the delivery of a tapered prompt 52. Subsequently, tapered responses 54, 56, 58, and 60 are delivered to the user.

If an incorrect response or a help prompt 62 is required in response to the answer to the full prompt 50, the pre-determined ratio of correct answers to full prompts can be increased. Hence, in the example of FIG. 2, the ratio can be increased from one to two. Thus, a first full prompt 64 and second full prompt 66 are delivered to the user. If these full prompts are answered correctly, tapered prompts 68, 70, and 72 are then delivered to the user.

If, in response to the full prompt 64, a response that is incorrect or otherwise results in a help prompt 74 is received, and subsequently an answer is again incorrect and results in a second incorrect response or help prompt 76, three full prompts 78, 80, and 82 are delivered and must be answered correctly in order that the user receive a tapered prompt 84. The dynamic sequential categorization technique can be programmed by speech-based interface developers to require any ratio of correct responses to full prompts. As a result, the dynamic sequential categorization techique is capable of significant flexibility in the manner by which it is determined when and where to deliver tapered prompts to users.

Like the dynamic sequential categorization technique, a criterion level categorization method in accordance with the present invention can include the establishment of an initial prerequisite ratio of correct responses to full prompts. Notwithstanding, uniquely the user's performance rating percentage,

(correct responses/(correct responses+errors))*100

also can be computed. This computed number of prerequisite responses can provide a minimum measure of accuracy before presenting tapered prompts and is highly relevant to the performance criterion. Once users respond to the prerequisite number of full prompts, the prompt delivery system continuously can calculate the percentage of correct responses and compare the percentage to a criterion level. When the percentage meets or exceeds the criterion level, the prompt delivery system can deliver tapered prompts to the user.

In accordance with the criterion level categorization method, users can continue to receive tapered prompts initially until the user's associated performance rating falls below the criterion level. When a user's performance rating falls below the criterion level the prompt delivery system reverts to presenting full prompts initially until the user meets or exceeds the criterion level again. Users failing to respond correctly to any tapered prompt subsequently can receive a full prompt. Users failing to respond correctly to the full prompt can receive a self-revealing help prompt. Notably, speech-based interface developers can choose to include or exclude the resulting full prompts or help prompts in the calculation of the performance ratings.

For example, if the prerequisite number of full prompts is set at three and the criterion level is set at 90%, and the user responds correctly to the first three full prompts, the performance rating is 100% (3/3*100). Therefore, the prompt delivery system can deliver tapered prompts thereafter since the performance rating of 100% exceeds the 90% criterion level. Conversely, should the user respond incorrectly to the initial tapered prompt, the user must respond correctly to the next six consecutive full prompts before receiving tapered prompts again (9/10*100). Therefore, speech-based interface developers incorporating the criterion level categorization method in a prompt delivery system can consider the relationship between the prerequisite number of full prompts and the established criterion level.

Notably, when applied to an interactive voice response (IVR) system, users of speech-based interface which incorporates a criterion level categorization method can receive a final rating of novice or expert based upon the mean overall performance rating during an entire call to the IVR system. This final rating can be used to determine the type of initial prompt presented to the user on the next call to the IVR system (i.e., tapered or full). As will be apparent to one skilled in the art, however, this particular application of the criterion level categorization method can require that personal profiles of overall user success rates are stored in a manner in which the profiles are accessible to the IVR system.

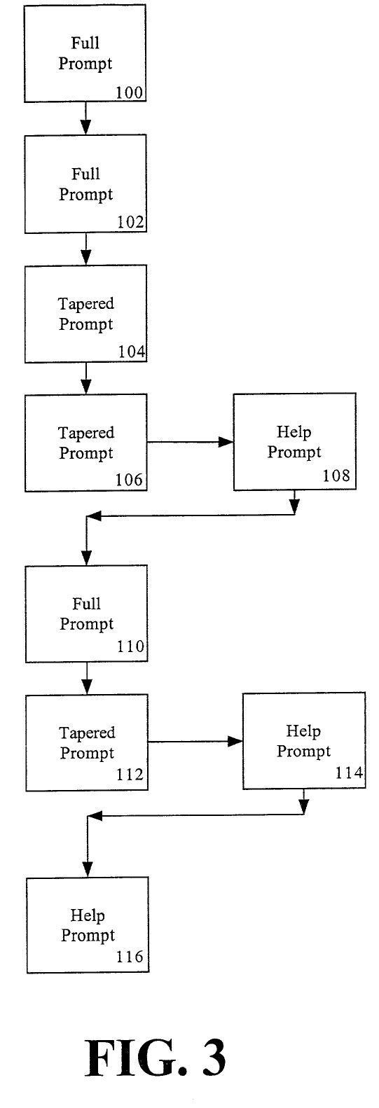

FIG. 3 illustrates an exemplary criterion level categorization method. According to the method shown in FIG. 3, the percentage of correct responses to prompts during a transaction is continuously calculated. The system calculates the performance rating percentage after users respond to a prerequisite number of full prompts on the first call to the system. The criterion level of correct responses must be surpassed before the user will receive tapered prompts. Users continue to receive tapered prompts until they respond incorrectly.

In the example shown in FIG. 3, the criterion level is set at 80%. A prerequisite full prompt 100 and a subsequent prerequisite full prompt 102 are delivered to the user and, if the user has responded correctly to both prerequisite full prompts, the performance rating is 100 percent and the user subsequently receives a tapered prompt 104. The user continues to receive tapered prompts 106. If an incorrect response is received or otherwise results in a help prompt 108, the performance rating falls to 75% [3/(3+1)*100=75%]. A full prompt is then delivered in step 110. If the user responds correctly, the performance rating increases to 80 percent [4/(4+1)*100=80%]. A tapered prompt is then delivered in step 112. If an incorrect response is received or otherwise results in a help prompt 114, the performance rating falls to 67% [4/(4+2)*100]. A full prompt 116 is then delivered to the user.

The system can calculate a final performance rating in order to determine whether the user is a novice or expert based on the mean overall performance rating during the entire call to the system. This final performance rating can be used to determine the initial prompt that will be presented to the user on the next call to the system. In the example shown in FIG. 3, the user has a performance rating which exceeds the criterion of 80% [5/(4+2)*100=83%]. The user is categorized as an expert, and starts with tapered prompts on the next call. Should the user respond incorrectly, the criterion is not met and results in categorization as a novice. The users must then provide correct answers to a sufficient number of full prompts such that the criterion level of 80% is attained before the user will again receive tapered prompts. Although the criterion level in the example is set at 80%, the criterion level could be higher or lower depending on the needs of the system developer.

Related to the criterion level categorization method, a segmented categorization technique can calculate a performance rating percentage for specific portions of the speech-based interface. In this technique, if a user performs poorly in one or more portions of an interactive speech-based application, referred to as segments, the user receives full prompts during that portion or segment on the next interaction. If a user performs particularly well on a segment of an application, the interface presents tapered prompts during that segment on subsequent interactions by the same user.

The segmented categorization method presents either full or tapered prompts for pre-defined segments of the interface based upon the performance ratings calculated [(correct responses/correct responses+errors)*100] within the established segments. This method is similar to the criterion level categorization method in that developers establish an initial prerequisite number of correct responses to full prompts before the system begins to calculate the users' performance rating percentage. However, this technique calculates multiple performance ratings within a system. For example, a system may have three applications available to users such as Library, Banking, or Calendar. Users meeting or exceeding the established performance criterion level within an application (or some pre-defined segment of a system), on the initial interaction, subsequently receive tapered prompts. By comparison, users not meeting or exceeding the performance criterion within an application receive full prompts.

This categorization technique adapts to the strengths and weaknesses of the user's interaction with the speech-based interface. Based upon independent performance ratings within each application (or other segmentation desired by developers) the interface changes prompts based upon the isolated performance ratings. Thus, on the next call the system determines whether to present full or tapered initial prompts within applications based upon the most recent performance rating within that particular application or segment for that user and not based upon an overall mean performance rating. However, the overall mean performance rating has an influence on the nature of the introduction (i.e., extensive versus concise introduction information). For example, based upon a user's mean overall performance rating users may hear an abbreviated introduction or the original introduction. This technique requires that the system create and retain a personal user profile to determine the style of introduction, as well as, the style of prompts within the individual segments.

The present invention provides a prompt delivery system which allows expert users to interact with a speech-based interface quickly and efficiently. Tapered prompts can be provided where possible, while the system can default to standard full prompts if the user fails to respond appropriately to tapered prompts. In addition, self-revealing help prompts can be provided when a user fails to respond appropriately even to a full prompt. This invention may be embodied in other specific forms without departing from the spirit of essential attributes thereof, and accordingly, reference should be had to the following claims, rather than to the foregoing specification, as indicating the scope of the invention.

We claim:

1. A categorized speech-based interface, comprising a prompt delivery system for delivering user prompts to users, each user prompts comprising at least one of a full prompt and a tapered prompt, said interface further comprising logic for determining the quantity of at least one of correct and incorrect responses to said user prompts, said prompt delivery system delivering tapered prompts in response to the determination of a quantity of said at least one of correct and incorrect responses.

2. The categorized speech interface of claim 1, wherein said prompt delivery system delivers tapered prompts in response to correct responses to a prerequisite number of full prompts.

3. The categorized speech-based interface of claim 2, wherein said prompt delivery system delivers tapered prompts to said user until said user provides an incorrect response.

4. The categorized speech-based interface of claim 3, wherein said prompt delivery system delivers full prompts following an incorrect response until a subsequent prerequisite number of correct responses are provided by a user.

5. The categorized speech-based interface of claim 2, wherein said prerequisite number of correct responses to full prompts is increased if an incorrect response is received.

6. The categorized speech-based interface of claim 5, wherein said prerequisite number of responses to full prompts is increased for each sequential incorrect response that is received.

7. The categorized speech-based interface of claim 1, wherein said incorrect responses include at least one selected from the group consisting of out-of-grammar responses, silence time outs, and help responses.

8. The categorized speech-based interface of claim 1, wherein said prompt delivery system delivers tapered prompts in response to a determination that correct responses have been provided by a user to a minimum prerequisite proportion of said prompts.

9. The categorized speech-based interface of claim 1, wherein said interface is segmented, and said prompt delivery system delivers tapered prompts in a segment in response to a determination that correct responses have been provided by a user to a prerequisite quantity of said prompts while in said segment.

10. The categorized speech-based interface of claim 9, wherein said prerequisite quantity of correct responses comprises a prerequisite number of sequential correct responses provided by the user while in said segment.

11. The categorized speech-based interface of claim 9, wherein said prerequisite quantity of correct responses comprises a prerequisite minimum proportion of correct responses provided by the user while in said segment.

12. A method for providing a categorized speech-based interface, comprising the steps of:
delivering user prompts to users, said prompts comprising at least full prompts and tapered prompts;
determining the quantity of at least one of correct and incorrect responses to said prompts;
delivering tapered prompts in response to the determination of a quantity of f at least one of said correct or incorrect responses.

13. The method of claim 12, wherein tapered prompts are delivered in response to determining that correct responses have been provided by a user to a prerequisite number of full prompts.

14. The method of claim 13, wherein tapered prompts are delivered when a prerequisite number of correct responses to full prompts are received.

15. The method of claim 13, wherein tapered prompts are delivered to said user until said user provides an incorrect response.

16. The method of claim 15, wherein full prompts are delivered following an incorrect response until a prerequisite number of correct responses are provided by a user.

17. The method of claim 13, wherein said prerequisite number of correct responses to full prompts is increased if an incorrect response is received.

18. The method of claim 17, wherein said prerequisite number of responses to full prompts is increased for each sequential incorrect response that is received.

19. The method of claim 12, wherein said incorrect responses include at least one selected from the group consisting of out-of-grammar responses, silence time outs, and help responses.

20. The method of claim 12, wherein tapered prompts are delivered in response to determining that correct responses have been provided by a user to a minimum prerequisite proportion of said prompts.

21. The method of claim 12, wherein said interface is segmented, and tapered prompts are delivered in a segment in response to determining that correct responses have been provided by a user to a prerequisite quantity of said prompts while in said segment.

22. The method of claim 21, wherein said prerequisite quantity of correct responses comprises a prerequisite number of sequential correct responses provided by the user while in said segment.

23. The method of claim 21, wherein said prerequisite quantity of correct responses comprises a prerequisite minimum proportion of correct responses provided by the user while in said segment.
